(19) United States
(12) Patent Application Publication
(10) Pub. No.: US 2025/0391162 A1
(43) Pub. Date: Dec. 25, 2025

(54) Sequential Modeling with Memory Including Multi-Range Arrays

(71) Applicant: Intel Corporation, Santa Clara, CA (US)

(72) Inventors: Ping Guo, Beijing (CN); Anbang Yao, Beijing (CN); Xiangbin Wu, Beijing (CN); Yufei Wu, Shanghai (CN); Mee Sim Lai, Penang (MY)

(21) Appl. No.: 19/107,538

(22) PCT Filed: Oct. 11, 2022
(86) PCT No.: PCT/CN2022/124510

§ 371 Date: Feb. 27, 2025

(51) Int. Cl. G06V 10/82; G06V 10/26; G06V 10/77; G06V 20/40

(52) U.S. Cl. CPC G06V 10/82; G06V 10/26; G06V 10/7715; G06V 20/49

(57) ABSTRACT

A system for video segmentation may include a neural network and a memory including multi-range arrays. The multi-range arrays may store feature map arrays including different number of feature maps. The system may generate a feature map from a frame in a video at a time and store the feature map in the memory. The feature map may be in a feature map array that also includes one or more contextual feature maps generated from other frames in the video. The system uses the feature map array to determine whether the frame falls into a segment of the video. The system may generate a new feature map later from another frame and include the new feature map in a new feature map array that also includes the first feature map. The system uses the new feature map array to determine whether the new frame falls into a segment.

### TECHNICAL FIELD

This disclosure relates generally to neural networks, and more specifically, sequential modeling with a memory including multi-range arrays.

### BACKGROUND

Deep neural networks (DNNs) are used extensively for a variety of artificial intelligence applications that include image processing and video segmentation. Video segmentation is a process of partitioning a video into disjoint sets of consecutive frames that are homogeneous according to some defined criteria, such as actions, scenes, shots, camera-takes, and so on. Video segmentation is important in various applications such as video indexing, video surveillance, autonomous driving, robotics, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates a video segmentation system, in accordance with various embodiments.

FIG. 3 illustrates sequential modeling for video segmentation, in accordance with various embodiments.

FIG. 4 illustrations initialization of a memory with multi-range arrays, in accordance with various embodiments.

FIG. 5 illustrations updates in a memory with multi-range arrays, in accordance with various embodiments.

FIG. 6 illustrates an example process of using a memory with multi-range arrays for video segmentation, in accordance with various embodiments.

FIG. 7 is a flowchart showing a method of video segmentation, in accordance with various embodiments.

FIG. 8 illustrates a deep learning environment, in accordance with various embodiments.

FIG. 9 is a block diagram of an example DNN system, in accordance with various embodiments.

FIG. 10 is a block diagram of an example computing device, in accordance with various embodiments.

### DETAILED DESCRIPTION

### Overview

The last decade has witnessed a rapid rise in AI (artificial intelligence) based data processing, particularly based on DNN. DNNs are widely used in the domains of computer vision, speech recognition, image, and video processing mainly due to their ability to achieve beyond human-level accuracy.

Despite that currently available neural networks can process short video clips well, they face challenges in handling long-term context in videos due to higher memory requirement and greater computational cost, especially for real-time online video processing applications. However, long-range context is important for action analysis. Taking a video of a basketball game for example, an action of passing basketball may not be distinguished from an action of shooting basketball without considering the long-range temporal dependencies.

To address the problem in video action segmentation tasks, currently available systems usually use sliding windows or recurrent networks. In the sliding window method, a large window size or even multi-scale windows are required to capture long-range context. Such a requirement can increase the processing time and increase the computation cost. When a small window size is used, the accuracy of the sliding window method can be deteriorated due to short range context. Recurrent networks typically maintain a historical memory by adding each frame features with a decay factor. A memory pool is designed to keep long-range context. However, far range features can be significantly decayed. Therefore, improved technology for video segmentation is needed.

Embodiments of the present disclosure may improve on at least some of the challenges and issues described above by providing a system and method for sequential modeling with a memory including multi-range arrays. The memory may facilitate video segmentation by a DNN based on long-range contexts. The DNN can achieve better accuracy and less processing time compared with currently available video segmentation technologies.

In various embodiments of the present disclosure, a system for video segmentation includes a DNN and a memory that includes multi-range arrays (or multi-range batches). An array (or batch) in the memory may store a feature map array (or feature map batch). The array may include a number of data storage units, each of which can store a feature map. The number of feature maps in the feature map array (i.e., the range of the feature map array) may be no greater than the number of data storage units in the memory array (i.e., the size of the memory array). One or more memory arrays may store different feature map arrays at different times. Different feature map arrays may include different numbers of feature maps generated from frames in different time ranges. The feature maps may be generated by feature extraction layers (e.g., convolutional layers) in the DNN.

In an example, the DNN may receive a first frame in a video at a first time. The DNN may generate a first feature map from the first frame. The first feature map is in a first feature map array that also includes one or more contextual feature maps. A contextual feature map may be a feature map generated by the DNN from a precedent frame, e.g., a frame that is precedent to the first frame in the video. The DNN may further process the first feature map array to determine whether the first frame falls into a segment of the video (e.g., whether the first frame falls into one of a plurality of segments of the video). At a second time that is later than the first time, the DNN may receive a second frame in the video and generate a second feature map from the second frame. The DNN may generate a second feature map array that includes the second feature map, the first feature map, and at least one of the one or more contextual feature maps in the first feature map array. In embodiments where the range of the first feature map array is smaller than the size of the memory array, the DNN may include all the contextual feature maps in the first feature map array into the second feature map array. In embodiments where the range of the first feature map array equals the size of the memory array, the DNN may remove one of the contextual feature maps in the first feature map array before the second feature map is stored, and the second feature map array may include one less contextual feature maps than the first feature map array. This process may continue till all the frames in the video is processed. In some embodiments, outputs of the DNN may be fed back into the DNN or fed into another DNN to improve accuracy in the classification or prediction. The other DNN may have the same or similar architecture as the DNN.

As the memory facilitates multi-range feature map arrays that are used by the DNN for video segmentation, the video segmentation in the present disclosure is done based on context data, which can be long distance context data. Thus, the system in the present disclosure can have good performance in video segmentation. The present disclosure can reduce memory cost as it may use a memory array having a fixed sized to store feature map arrays of various ranges. The memory cost can be dependent on the size (e.g., the maximum length) of the memory array and the ranges of the feature map arrays. The present disclosure can also reduce computation cost by facilitating real-time frame processing. The system in the present disclosure is capable of online long-range context modeling.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

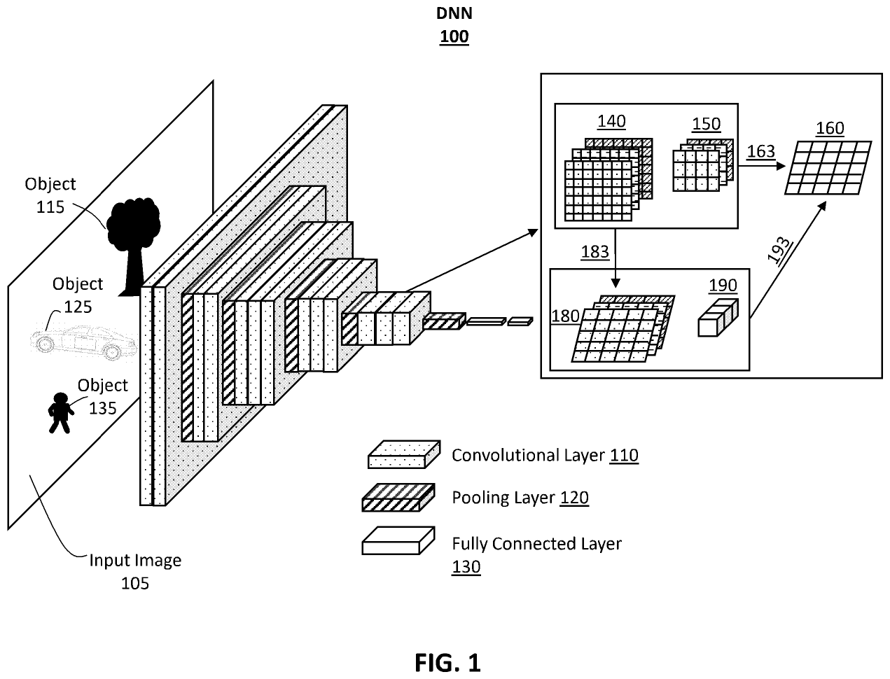

FIG. 1 illustrates an example DNN 100, in accordance with various embodiments. For purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the individual partial sum includes 3 probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example Video Segmentation System

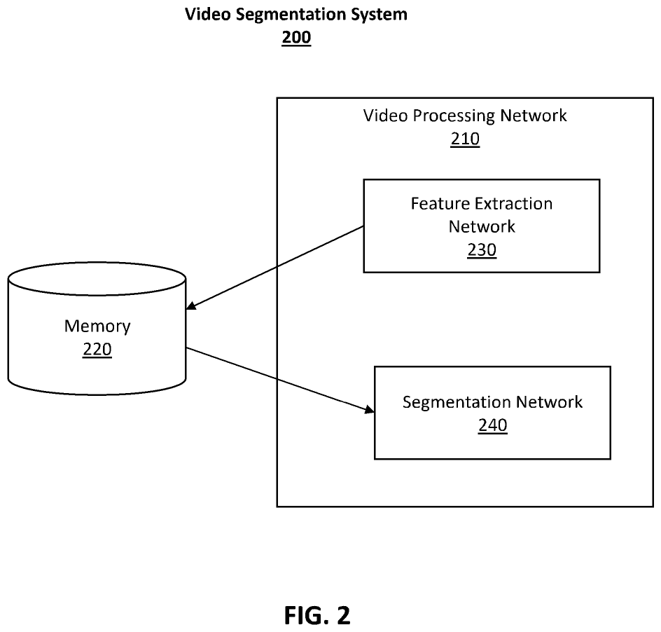

FIG. 2 illustrates a video segmentation system 200, in accordance with various embodiments. The video segmentation system 200 incudes a video processing network 210 and a memory 220. The video processing network 210 includes a feature extraction network 230 and a segmentation network 240. In other embodiments, alternative configurations, different or additional components may be included in the video segmentation system 200. For instance, the video segmentation system 200 may include more than one memory 220. Also, the video segmentation system 200 may include more than feature extraction network 230. Further, functionality attributed to a component of the video segmentation system 200 may be accomplished by a different component included in the video segmentation system 200 or by a different system.

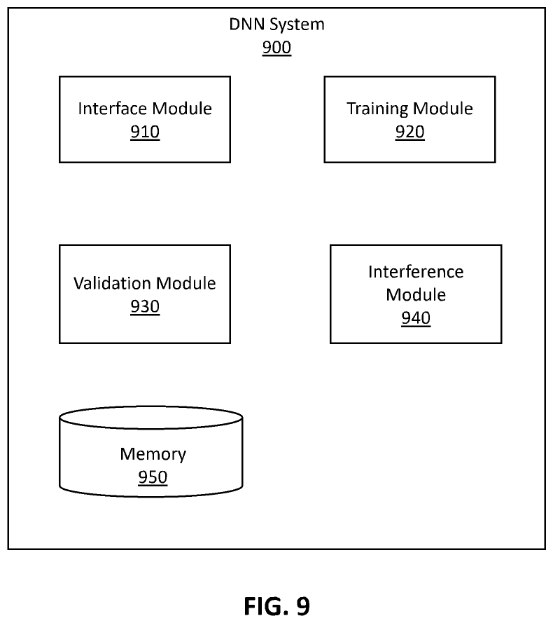

The video processing network 210 is a DNN that processes videos. An example of the video processing network 210 may be the DNN 100 shown in FIG. 1. The video processing network 210 may have internal parameters, e.g., weights, the value of which may be determining during the training of the video processing network 210. The video processing network 210 may be trained by the training module 920 in FIG. 9.

As shown in FIG. 2, the video processing network 210 includes a feature extraction network 230 and a segmentation network 240. The feature extraction network 230 includes one or more feature extraction layers. A feature extraction layer may receive an input and outputs an output feature map by extracting features from the input. The input may be a frame or a feature map generated by another feature extraction layer. In some embodiments, the feature extraction network 230 includes one or more convolutional layers, e.g., convolutional layers 110 in FIG. 1. The feature extraction network 230 may also include one or more non-linear layers. The feature extraction network 230 may process different frames at different times. In an example where the video processing network 210 receives a streamed video, the feature extraction network 230 may generate feature maps from the stream video at real-time. In some embodiments, the feature extraction network 230 may receive a first frame at a first time, e.g., a time when the first frame is streamed. One or more layers in the feature extraction network 230 may extract features from the frame and generate a first feature map. At a second time that is later than the first time, the feature extraction network 230 may receive a second frame. One or more layers in the feature extraction network 230 may extract features from the second frame and generate a second feature map. Feature maps generated by the feature extraction network 230 are stored in the memory 220.

For purpose of illustration, FIG. 2 shows one pair of the memory 220 and the feature extraction network 230. In other embodiments, the video segmentation system 200 may include multiple pairs of the memory 220 and the feature extraction network 230. Feature extraction may be iteratively performed by using the multiple pairs of the memory 220 and the feature extraction network 230. For instance, a first round of feature extraction may be performed by a first pair of the memory 220 and the feature extraction network 230, followed by a second round of feature extraction performed by a second pair of the memory 220 and the feature extraction network 230. The second round may be further followed by a third round, and so on. Each round of feature extraction may be performed by a different pair of the memory 220 and the feature extraction network 230. In some embodiments, a pair of the memory 220 and the feature extraction network 230 may perform more than one round of feature extraction.

The segmentation network 240 includes one or more segmentation layers. A segmentation layer may receive an output from the feature extraction network 230 or from another segmentation layer as an input. The segmentation layer may output a label. The label may indicate a determination of the video processing network 210, e.g., a determination whether a frame in the video falls into a segment. In some embodiments, a label may be a classification of an object in a frame of the video, an action shown in the frame, other types of labels or some combination thereof. In other embodiments, the video processing network 210 may include other layers. The segmentation network 240 may process different feature maps at different times. The segmentation network 240 may process a set of feature maps at a time to determine whether a frame is in a segment of the video. For instance, the segmentation network 240 may identify a segment into which the frame falls. The set of feature maps may include a feature map generated from the frame itself and one or more feature maps generated from precedent frames. The segmentation network 240 may repeat this processing till the segment of the last frame is determined.

In some embodiments, the video processing network 210 may receive a video as an input. A video includes a sequence of frames. In some embodiments, the video processing network 210 may process a streaming input, e.g., a video streamed online. A streaming input may be denoted as X=x₀, x₁, . . . , x_{N}, where x denotes a frame in the video, and N is an integer that is greater than 1. Each frame x may correspond to a timestamp in the video, and the order of the frames in the video may be dependent on the order of the timestamps of the frames. The video processing network 210 may output information indicating segmentation of the video. For instance, the video processing network 210 may divide the video into segments, each of which may include a plurality of consecutive frames that are in the same category. The category may be an action, a scene, a camera-take, a shot, etc.

In some embodiments, the video processing network 210 may be a sequential model denoted as:

$${y}_{t} = g ( {x}_{t} , {m}_{t} )$$

$${m}_{t} = [ {m}_{t}^{l} ] ( l = 1 , ... L - 1 )$$

where yₜ denotes output of the video processing network 210, mₜ denotes feature maps stored in the memory 220 at a time t. The feature maps may be generated at times before the time t and therefore, may be referred to as contextual feature maps. In some embodiments, the function g(·) is a stack of one-dimensional (1D) convolutions with filters kₗ (l=1, . . . . L), where L denotes the maximum temporal range of the contextual feature maps stored in the memory 220. The output yₜ may be denoted as:

$${y}_{t} = {k}_{L} ( ... ... ( {k}_{1} ( {k}_{0} ( {x}_{t} , {m}_{t}^{0} ) , {m}_{t}^{1} ) , {m}_{t}^{L} ) ,$$

The memory 220 stores data associated with the video processing network 210. For instance, the memory 220 may store data received by the video processing network 210, such as videos. The memory 220 may also store data generated by the video processing network 210, such as feature maps, labels, segmentation information, and so on. In some embodiments, the memory 220 include multi-range arrays. An array in the memory 220 may include a sequence of data storage units, each of which may store a feature map generated by a layer in the feature extraction network 230. Different arrays may correspond to different layers in the feature extraction network 230. Each layer in the feature extraction network 230 may be associated with a separate array in the memory 220.

An array may store one or more feature maps generated by the corresponding layer. In some embodiments, the data stored in an array may change with time. For instance, at a first time, an array may include a first feature map generated from a first frame. The first feature map may be generated at the first time or at a time that is substantially close to the first time. The array may also include one or more contextual feature maps. A contextual feature map may be a feature map generated at an earlier time than the first feature map and may be generated based on a contextual frame in the video. The contextual frame may precede the first frame in the video. The contextual feature maps can provide context for the first feature map of the first frame and therefore, can facilitate the segmentation network 240 to determine whether the first frame falls into a segment of the video.

At a second time that is later than the first time, the array may include a second feature map generated from a second frame. The second feature map may be generated at the second time or at a time that is substantially close to the second time. To store the second feature map in the array, one of the contextual feature maps may be removed from the array. After storing the second feature map, the array includes the first feature map and the second feature map. The array may also include at least one of the contextual feature maps. All the feature maps in the array may be provided to the segmentation network 240 to determine whether the second frame falls into a segment of the video.

In some embodiments, the numbers of feature maps stored in different arrays may be different. As the feature maps in an array are generated at different times, the number of feature maps in an array may define a time range of the array. The time range is related to the number of contextual feature maps included in the array. An array having a longer time range may include more contextual feature maps than an array having a shorter time range. The time range may also be referred to as a context range or a range. As different array may have different temporal ranges, the memory 220 can be a multi-range array memory. In some embodiments, the range of an array may be a learnable parameter, the value of which can be determined through training the video processing network 210. In some embodiments, the memory 220 may have a fixed maximum range, which is equal to or greater than the range of each of the arrays in the memory 220.

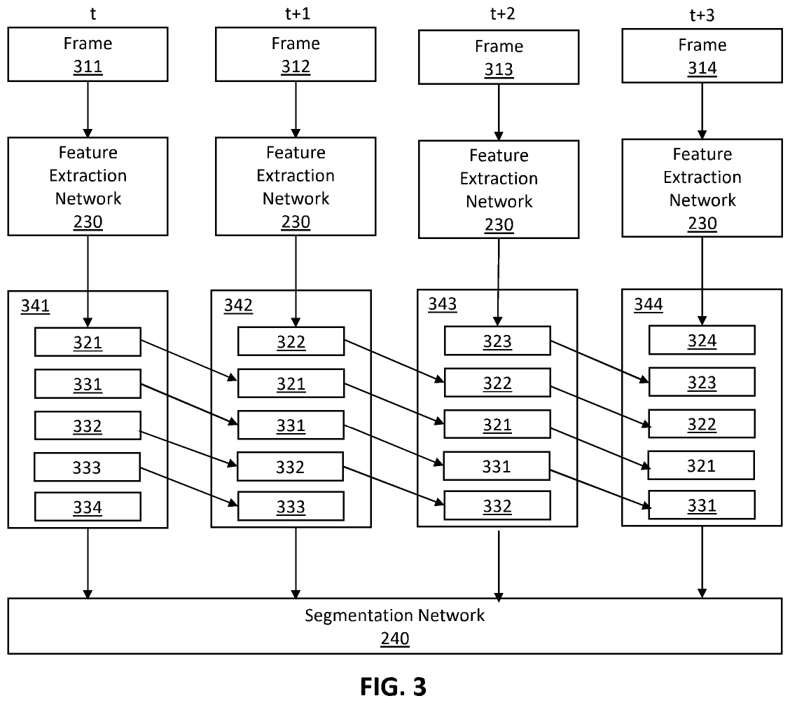

FIG. 3 illustrates sequential modeling for video segmentation, in accordance with various embodiments. The sequential modeling may be done through the video segmentation system 200 in FIG. 2. The sequential modeling in FIG. 3 may be run iteratively by the video segmentation system 200. FIG. 3 shows modeling of frames in a video by the video segmentation system 200 at a sequence of timestamps: t, t+1, t+2, t+3, and t+4.

At the time stamp t, a frame 311 is received by the video segmentation system 200. The time stamp t may indicate a time when the frame 311 is streamed or is made available to audience. The frame 311 is provided to the feature extraction network 230. The feature extraction network 230 generates a feature map 321 from the frame 311. The feature map 321 is saved to the memory 220. The memory 220 also saves contextual feature maps 331, 332, 333, and 334. The contextual feature maps 331, 332, 333, and 334 may be generated, e.g., by the feature extraction network 230 from frames that are precedent to the frame 311 in the video. In some embodiments, the precedent frames and the frame 311 may be consecutive frames. The contextual feature maps 331, 332, 333, and 334 may be arranged in an order determined based on timestamps of the precedent frames from which the contextual feature maps 331, 332, 333, and 334 are generated. For instance, the timestamp of the frame for the contextual feature map 331 may be later than the timestamp of the frame for the contextual feature map 332, which may be later than the timestamp of the frame for the contextual feature map 333. The timestamp of the frame for the contextual feature map 334 may be the earlier than the timestamp of the frame for the contextual feature map 333.

The feature map 321 and the contextual feature maps 331, 332, 333, and 334 constitutes a feature map array 341. The feature map array 341 is provided to the segmentation network 240. The segmentation network 240 may determine whether the frame 311 falls into a video segment based on the feature map array 341. The feature map array 341 includes a range of 5, as it includes 5 feature maps in total. In other embodiments, the feature map array 341 may have a different range. As the feature map array 341 includes history data in the video (i.e., the contextual feature maps 331, 332, 333, and 334), the determination made by the segmentation network 240 can be more accurate than embodiments where no history data or less history data is used.

At the time stamp t+1, a frame 312 is received by the video segmentation system 200. The time stamp t may indicate a time when the frame 312 is streamed or is made available to audience. The frame 312 may be right after the frame 311 in the video. The frame 312 is provided to the feature extraction network 230. The feature extraction network 230 generates a feature map 322 from the frame 312. The feature map 322 is saved to the memory 220, and the feature map array 341 is changed to a feature map array 342. The feature map 322 is the first feature map in the feature map array 342 and is followed by the feature map 321 generated at the time stamp t. The feature map array 342 also includes the contextual feature maps 331, 332, and 333. The feature map array 342 does not include the contextual feature map 334 as the maximum range of a feature map array in the memory 220 is 5. The contextual feature map 334 may be removed from the memory 220 before the feature map 322 is stored. The feature map array 342 is provided to the segmentation network 240. The segmentation network 240 may determine whether the frame 312 falls into a video segment based on the feature map array 342.

At the time stamp t+2, a frame 313 is received by the video segmentation system 200. The time stamp t may indicate a time when the frame 313 is streamed or is made available to audience. The frame 313 may be right after the frame 312 in the video. The frame 313 is provided to the feature extraction network 230. The feature extraction network 230 generates a feature map 323 from the frame 313. The feature map 323 is saved to the memory 220, and the feature map array 342 is changed to a feature map array 343. The feature map 323 is the first feature map in the feature map array 343 and is followed by the feature map 322 generated at the time stamp t+1, further followed by the feature map 321 generated at the time stamp t. The feature map array 343 also includes the contextual feature maps 331 and 332. The contextual feature map 333 may be removed from the memory 220 before the feature map 323 is stored. The feature map array 343 is provided to the segmentation network 240. The segmentation network 240 may determine whether the frame 313 falls into a video segment based on the feature map array 343.

At the time stamp t+3, a frame 314 is received by the video segmentation system 200. The time stamp t may indicate a time when the frame 314 is streamed or is made available to audience. The frame 314 may be right after the frame 313 in the video. The frame 314 is provided to the feature extraction network 230. The feature extraction network 230 generates a feature map 324 from the frame 314. The feature map 324 is saved to the memory 220, and the feature map array 343 is changed to a feature map array 344. The feature map 324 is the first feature map in the feature map array 344 and is followed by the feature map 323. The feature map array 344 also includes the contextual feature map 331. The contextual feature map 332 may be removed from the memory 220 before the feature map 324 is stored. The feature map array 344 is provided to the segmentation network 240. The segmentation network 240 may determine whether the frame 314 falls into a video segment based on the feature map array 344.

For purpose of illustration, FIG. 3 shows four timestamps. In other embodiments, the sequential modeling may include modeling for a different number of timestamps. Also, the range of the feature map arrays 341, 342, 343, and 344 is 5, which is the maximum range of a feature map array in the memory 220. In other embodiments, a feature map array may have a different range. Also, different feature map arrays may have different ranges. The maximum range in the memory 220 may be a different range.

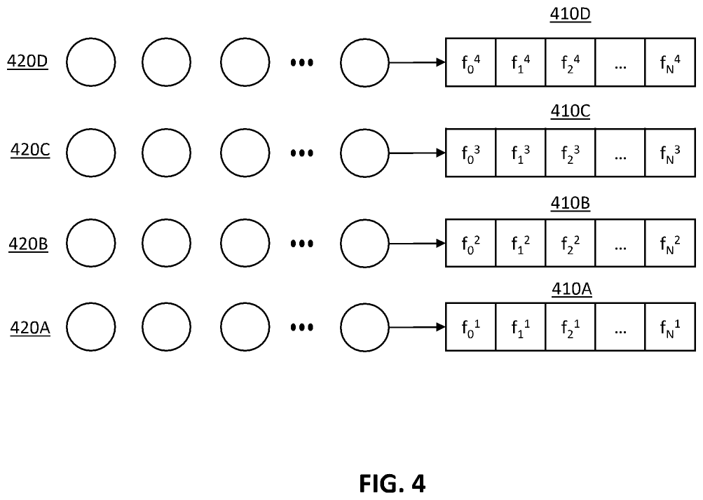

FIG. 4 illustrations initialization of a memory with multi-range arrays, in accordance with various embodiments. The memory may be an embodiment of the memory 220 in FIG. 2. For purpose of simplicity and illustration, FIG. 4 shows four feature map arrays 410A-410D (collectively referred to as “feature map arrays 410” or “feature map arrays 410”) that include feature maps generated by four layers 420A-420D. The four layers 420A-420D (collectively referred to as “layers 420” or “layer 420”) may be four layers in the feature extraction network 230. Each feature map array 410 corresponds to a different layer 420. Each circle in FIG. 4 represents a layer 420 at a time. A layer 420 generates a plurality of feature maps at a sequence of times.

Each feature map array 410 includes N feature maps. Each feature map is denoted as fᵢⁱ, where i denotes the time, and j denotes the layer. Each feature map may be generated at a different time. The order of the feature maps in a feature map array may be determined based on the times when the feature maps are generated. The layer 420A generates the feature map array 410A, which includes the feature maps f₀¹-f_{N}¹, at a sequence of N times. The layer 420B generates the feature map array 410B, which includes the feature maps f₀²-f_{N}², at a sequence of N times. The layer 420C generates the feature map array 410C, which includes the feature maps f₀³-f_{N}³, at a sequence of N times. The layer 420D generates the array 410D, which includes the feature maps f₀⁴-f_{N}⁴, at a sequence of N times. In some embodiments, the layers 420 are arranged in a sequence, where the layer 420A is the first layer, the layer 420B is the second layer, the layer 420C is the third layer, and the layer 420D is the fourth layer.

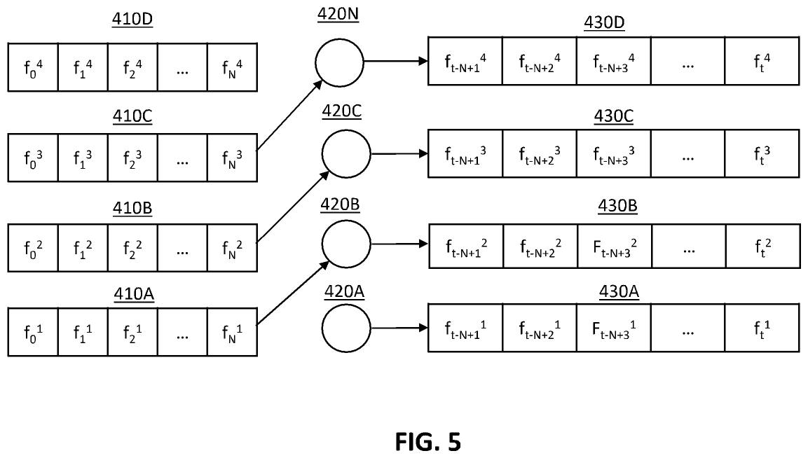

FIG. 5 illustrations updates in a memory with multi-range arrays, in accordance with various embodiments. The memory in FIG. 5 may be the memory in FIG. 4. The updates may occur at a time t. The feature map arrays 410 are updated in FIG. 5, and new feature map arrays 430A-430D (collectively referred to as “feature map arrays 430” or “feature map arrays 430”) are generated at the time t. In the embodiment of FIG. 5, the feature map array 410A is input into the layer 420B. The layer 420B may perform convolutions on the feature maps in the feature map array 410A to generate feature maps in the feature map array 430B at the time t. Similarly, the feature map array 410B is input into the layer 420C. The layer 420C may perform convolutions on the feature maps in the feature map array 410B to generate feature maps in the feature map array 430C at the time t. The feature map array 410C is input into the layer 420D. The layer 420D may perform convolutions on the feature maps in the feature map array 410C to generate feature maps in the feature map array 430D at the time t. The feature map array 430A is generated by the layer 420A at the time t, and the feature maps in the feature map array 430A may be different from the feature maps in the feature map array 410A.

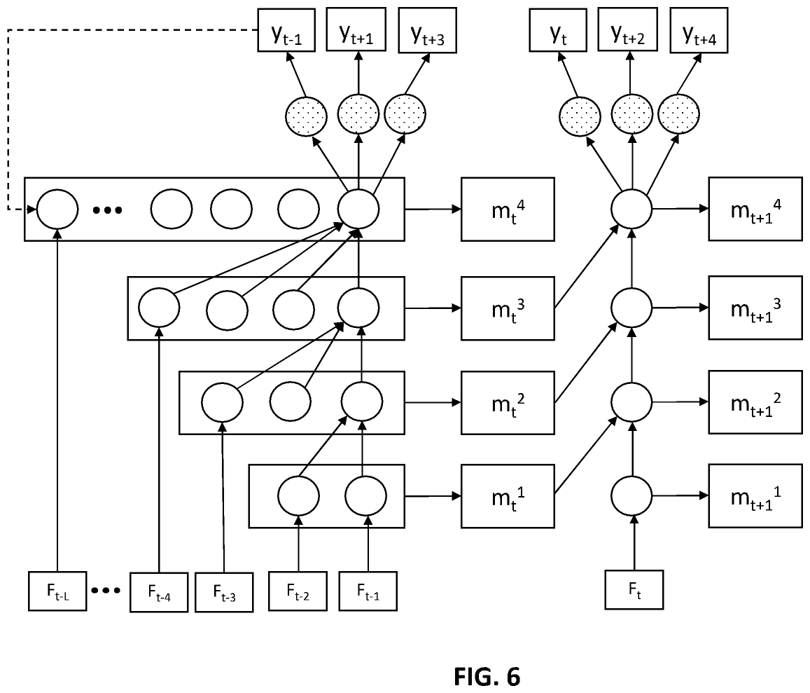

FIG. 6 illustrates an example process of using a memory with multi-range arrays for video segmentation, in accordance with various embodiments. FIG. 6 also shows feature extraction layers represented by unhighlighted circles and segmentation layers represented by highlighted circles (highlighted with dot patterns in FIG. 6). By a time t−1, a sequence of frames F_{t-L}, . . . , Fₜ₋₄, Fₜ₋₃, Fₜ₋₂, Fₜ₋₁ have been provided. The frames are input into the feature extract layers at different times, and feature maps are generated. Multi-range arrays including the feature maps are formed in the memory. An example of the memory is the memory 220 in FIG. 2. FIG. 6 shows four arrays mₜ¹, mₜ², mₜ³, and mₜ⁴ that have different ranges. The array mₜ¹ includes two feature maps generated from the frames Fₜ₋₂ and Fₜ₋₁. The array mₜ² includes three feature maps generated from the frames Fₜ₋₃ to Fₜ₋₁. The array mₜ³ includes four feature maps generated from the frames Fₜ₋₄ to Fₜ₋₁. The array mₜ⁴ includes L feature maps generated from the frames Fₜ₋₄ to Fₜ₋₁.

At a time t, the frame Fₜ is input into a feature extract layer, which may be the first feature extract layer in the feature extraction network 230, which generates an array mₜ₊₁¹. The array mₜ₊₁¹ may include the feature map generated from the frame Fₜ by the layer. The array mₜ₊₁¹ and the array mₜ¹ are input into the second layer, which generates an array mₜ₊₁². The array mₜ₊₁² may include three feature maps generated by the second layer: a feature map generated from the array mₜ₊₁¹ and two feature maps generated by the array mₜ². Similarly, the array mₜ₊₁² and the array mₜ² are input into the third layer, which generates an array mₜ₊₁³ that may include four feature maps. The array mₜ₊₁³ and the array mₜ³ are input into the fourth layer, which generates an array mₜ₊₁⁴ that may include five feature maps.

FIG. 6 also shows that at the time t−1, a segmentation layer outputs a classification yₜ₋₁ for the frame Fₜ₋₁ and two predictions yₜ₊₁ and yₜ₊₃. The classification yₜ₋₁ may indicate a segment that the frame Fₜ₋₁ falls into. The two predictions yₜ₊₁ and yₜ₊₃ may indicate predictions of which segment(s) subsequent frames fall into. The classification yₜ₋₁ and predictions yₜ₊₁ and yₜ₊₃ are generated based on the current frame Fₜ₋₁ and the historical data, i.e., feature maps generated from the precedent frames F_{t-L} to Fₜ₋₂. Similarly, at the time t, a segmentation layer outputs a classification yₜ for the frame Fₜ and two predictions yₜ₊₂ and yₜ₊₄. The classification yₜ may indicate a segment that the frame Fₜ falls into. The two predictions yₜ₊₂ and yₜ₊₄ may indicate predictions of which segment(s) subsequent frames fall into. The classification yₜ₋₁ and predictions yₜ₊₂ and yₜ₊₄ are generated based on the current frame Fₜ and the historical data, i.e., feature maps generated from the precedent frames F_{t-L} to Fₜ₋₁.

In some embodiments, some or all of the outputs of the feature extraction layers (e.g., the feature maps in the arrays) or the segmentation layer (e.g., the classification yₜ₋₁, the predictions yₜ₊₁ and yₜ₊₃, the classification yₜ₋₁, and the predictions yₜ₊₂ and yₜ₊₄) may be fed into a network for further processing. The network can generate new outputs, which may be better video segmentation results. The network may have the same or similar architecture as the video processing network 210 in FIG. 2 or a portion of the video processing network 210.

### Example Method of Video Segmentation

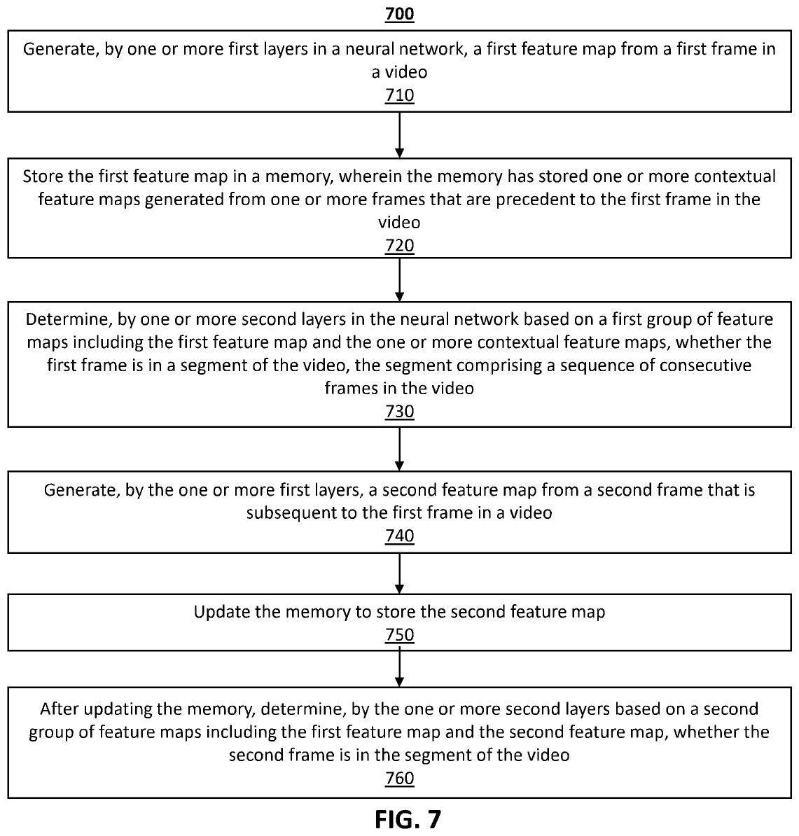

FIG. 7 is a flowchart showing a method 700 of video segmentation, in accordance with various embodiments. The method 700 may be performed by the video segmentation system 200 in FIG. 2. Although the method 700 is described with reference to the flowchart illustrated in FIG. 7, many other methods for video segmentation may alternatively be used. For example, the order of execution of the steps in FIG. 7 may be changed. As another example, some of the steps may be changed, eliminated, or combined.

The video segmentation system 200 generates 710, by one or more first layers in a neural network, a first feature map from a first frame in a video. In some embodiments, the one or more first layers comprise a convolutional layer.

The video segmentation system 200 stores 720 the first feature map in a memory. The memory has stored one or more contextual feature maps generated from one or more frames that are precedent to the first frame in the video. In some embodiments, the one or more first layers comprises a first layer and a second layer. The first feature map is generated by the first layer, and a contextual feature map is generated by the second layer. In some embodiments, the first group of feature maps is stored in an order in the memory. The order is determined based on times when the feature maps in the first group are generated.

The video segmentation system 200 determines 730, by one or more second layers in the neural network based on a first group of feature maps including the first feature map and the one or more contextual feature maps, whether the first frame is in a segment of the video. The segment comprises a sequence of consecutive frames in the video.

The video segmentation system 200 generates 740, by the one or more first layers, a second feature map from a second frame that is subsequent to the first frame in a video.

The video segmentation system 200 updates 750 the memory to store the second feature map. In some embodiments, the video segmentation system 200 removes one of the one or more contextual feature maps from the memory. In some embodiments, the video segmentation system 200 may perform some or all of the steps 730, 740, and 750 iteratively.

After updating the memory, the video segmentation system 200 determines 760, by the one or more second layers based on a second group of feature maps including the first feature map and the second feature map, whether the second frame is in the segment of the video. In some embodiments, a number of feature maps in the first group of feature maps is different from a number of feature maps in the second group of feature maps.

In some embodiments, the video segmentation system 200 generates, by the one or more first layers, a third feature map from the first feature map. The video segmentation system 200 may store the third feature map in a memory. After storing the third feature map, the video segmentation system 200 may retrieve a third group of feature maps from the memory. The third group of feature maps comprises the third feature map and the one or more contextual feature maps. The video segmentation system 200 may determine, by the one or more second layers based on the third group of feature maps, whether the first frame is in the segment of the video.

### Example Deep Learning Environment

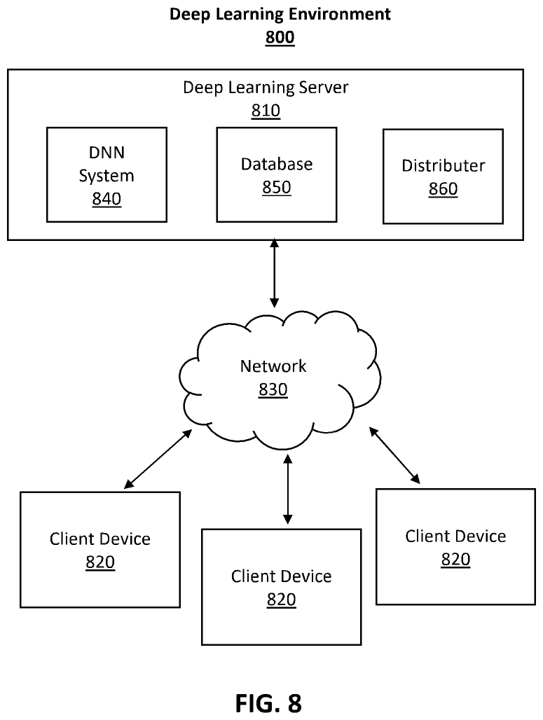

FIG. 8 illustrates a deep learning environment 800, in accordance with various embodiments. The deep learning environment 800 includes a deep learning server 810 and a plurality of client devices 820 (individually referred to as client device 820). The deep learning server 810 is connected to the client devices 820 through a network 830. In other embodiments, the deep learning environment 800 may include fewer, more, or different components.

The deep learning server 810 trains deep learning models using neural networks. A neural network is structured like the human brain and consists of artificial neurons, also known as nodes. These nodes are stacked next to each other in 3 types of layers: input layer, hidden layer(s), and output layer. Data provides each node with information in the form of inputs. The node multiplies the inputs with random weights, calculates them, and adds a bias. Finally, non-linear functions, also known as activation functions, are applied to determine which neuron to fire. The deep learning server 810 can use various types of neural networks, such as DNN, recurrent neural network (RNN), generative adversarial network (GAN), long short-term memory network (LSTMN), and so on. During the process of training the deep learning models, the neural networks use unknown elements in the input distribution to extract features, group objects, and discover useful data patterns. The deep learning models can be used to solve various problems, e.g., making predictions, classifying images, and so on. The deep learning server 810 may build deep learning models specific to particular types of problems that need to be solved. A deep learning model is trained to receive an input and outputs the solution to the particular problem.

In FIG. 8, the deep learning server 810 includes a DNN system 840, a database 850, and a distributer 860. The DNN system 840 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1. In some embodiments, the DNN system 840 trains DNNs through knowledge distillation, e.g., dense-connection based knowledge distillation. The trained DNNs may be used on low memory systems, like mobile phones, IOT edge devices, and so on.

The database 850 stores data received, used, generated, or otherwise associated with the deep learning server 810. For example, the database 850 stores a training dataset that the DNN system 840 uses to train DNNs. In an embodiment, the training dataset is an image gallery that can be used to train a DNN for classifying images. The training dataset may include data received from the client devices 820. As another example, the database 850 stores hyperparameters of the neural networks built by the deep learning server 810.

The distributer 860 distributes deep learning models generated by the deep learning server 810 to the client devices 820. In some embodiments, the distributer 860 receives a request for a DNN from a client device 820 through the network 830. The request may include a description of a problem that the client device 820 needs to solve. The request may also include information of the client device 820, such as information describing available computing resource on the client device. The information describing available computing resource on the client device 820 can be information indicating network bandwidth, information indicating available memory size, information indicating processing power of the client device 820, and so on. In an embodiment, the distributer may instruct the DNN system 840 to generate a DNN in accordance with the request. The DNN system 840 may generate a DNN based on the information in the request. For instance, the DNN system 840 can determine the structure of the DNN and/or train the DNN in accordance with the request.

In another embodiment, the distributer 860 may select the DNN from a group of pre-existing DNNs based on the request. The distributer 860 may select a DNN for a particular client device 820 based on the size of the DNN and available resources of the client device 820. In embodiments where the distributer 860 determines that the client device 820 has limited memory or processing power, the distributer 860 may select a compressed DNN for the client device 820, as opposed to an uncompressed DNN that has a larger size. The distributer 860 then transmits the DNN generated or selected for the client device 820 to the client device 820.

In some embodiments, the distributer 860 may receive feedback from the client device 820. For example, the distributer 860 receives new training data from the client device 820 and may send the new training data to the DNN system 840 for further training the DNN. As another example, the feedback includes an update of the available computing resource on the client device 820. The distributer 860 may send a different DNN to the client device 820 based on the update. For instance, after receiving the feedback indicating that the computing resources of the client device 820 have been reduced, the distributer 860 sends a DNN of a smaller size to the client device 820.

The client devices 820 receive DNNs from the distributer 860 and applies the DNNs to perform machine learning tasks, e.g., to solve problems or answer questions. In various embodiments, the client devices 820 input images into the DNNs and use the output of the DNNs for various applications, e.g., visual reconstruction, augmented reality, robot localization and navigation, medical diagnosis, weather prediction, and so on. A client device 820 may be one or more computing devices capable of receiving user input as well as transmitting and/or receiving data via the network 830. In one embodiment, a client device 820 is a conventional computer system, such as a desktop or a laptop computer. Alternatively, a client device 820 may be a device having computer functionality, such as a personal digital assistant (PDA), a mobile telephone, a smartphone, an autonomous vehicle, or another suitable device. A client device 820 is configured to communicate via the network 830. In one embodiment, a client device 820 executes an application allowing a user of the client device 820 to interact with the deep learning server 810 (e.g., the distributer 860 of the deep learning server 810). The client device 820 may request DNNs or send feedback to the distributer 860 through the application. For example, a client device 820 executes a browser application to enable interaction between the client device 820 and the deep learning server 810 via the network 830. In another embodiment, a client device 820 interacts with the deep learning server 810 through an application programming interface (API) running on a native operating system of the client device 820, such as IOS® or ANDROID™.

In an embodiment, a client device 820 is an integrated computing device that operates as a standalone network-enabled device. For example, the client device 820 includes display, speakers, microphone, camera, and input device. In another embodiment, a client device 820 is a computing device for coupling to an external media device such as a television or other external display and/or audio output system. In this embodiment, the client device 820 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 820 may be configured to be compatible with a generic external media device that does not have specialized software, firmware, or hardware specifically for interacting with the client device 820.

The network 830 supports communications between the deep learning server 810 and client devices 820. The network 830 may comprise any combination of local area and/or wide area networks, using both wired and/or wireless communication systems. In one embodiment, the network 830 may use standard communications technologies and/or protocols. For example, the network 830 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 830 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 830 may be represented using any suitable format, such as hypertext markup language (HTML) or extensible markup language (XML). In some embodiments, all or some of the communication links of the network 830 may be encrypted using any suitable technique or techniques.

### Example DNN System

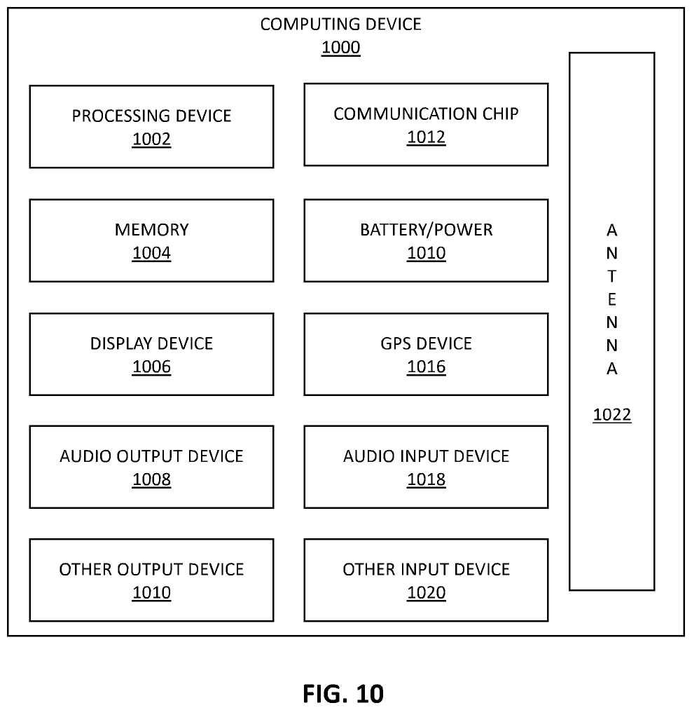

FIG. 9 is a block diagram of an example DNN system 900, in accordance with various embodiments. The whole DNN system 900 or a part of the DNN system 900 may be implemented in the computing device 1000 in FIG. 10. The DNN system 900 trains DNNs for various tasks, such as image classification, learning relationships between biological cells (e.g., DNA, proteins, etc.), control behaviors for devices (e.g., robots, machines, etc.), and so on. The DNN system 900 includes an interface module 910, a training module 920, a validation module 930, an inference module 940, and a memory 950. In other embodiments, alternative configurations, different or additional components may be included in the DNN system 900. Further, functionality attributed to a component of the DNN system 900 may be accomplished by a different component included in the DNN system 900 or a different system. The DNN system 900 or a component of the DNN system 900 (e.g., the training module 920 or inference module 940) may include the computing device 1400.

The interface module 910 facilitates communications of the DNN system 900 with other systems. For example, the interface module 910 establishes communications between the DNN system 900 with an external database to receive data that can be used to train DNNs or input into DNNs to perform tasks. As another example, the interface module 910 supports the DNN system 900 to distribute DNNs to other systems, e.g., computing devices configured to apply DNNs to perform tasks.

The training module 920 trains DNNs by using a training dataset. The training module 920 forms the training dataset. In an embodiment where the training module 920 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 930 to validate performance of a trained DNN. The portion of the training dataset not including the tuning subset and the validation subset may be used to train the DNN.

The training module 920 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 9, 90, 500, 900, or even larger.

The training module 920 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 920 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 920 defines the architecture of the DNN, the training module 920 inputs a training dataset into the DNN. The training dataset includes a plurality of training samples. An example of a training sample includes an object in an image and a ground-truth label of the object. The training module 920 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 920 uses a cost function to minimize the error.

The training module 920 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 920 finishes the predetermined number of epochs, the training module 920 may stop updating the parameters in the DNN. The DNN having the updated parameters is referred to as a trained DNN.

The validation module 930 verifies accuracy of trained DNNs. In some embodiments, the validation module 930 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 930 may determine an accuracy score measuring the precision, recall, or a combination of precision and recall of the DNN. The validation module 930 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 930 may compare the accuracy score with a threshold score. In an example where the validation module 930 determines that the accuracy score of the augmented model is lower than the threshold score, the validation module 930 instructs the training module 920 to re-train the DNN. In one embodiment, the training module 920 may iteratively re-train the DNN until the occurrence of a stopping condition, such as the accuracy measurement indication that the DNN may be sufficiently accurate, or a number of training rounds having taken place.

The inference module 940 applies the trained or validated DNN to perform tasks. For instance, the inference module 940 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 940 distributes the DNN to other systems, e.g., computing devices in communication with the DNN system 900, for the other systems to apply the DNN to perform the tasks.

The memory 950 stores data received, generated, used, or otherwise associated with the DNN system 900. For example, the memory 950 stores the datasets used by the training module 920 and validation module 930. The memory 950 may also store data generated by the training module 920 and validation module 930, such as the hyperparameters for training DNNs, internal parameters of trained DNNs (e.g., values of tunable parameters of activation functions, such as Fractional Adaptive Linear Units (FALUs)), etc. In the embodiment of FIG. 9, the memory 950 is a component of the DNN system 900. In other embodiments, the memory 950 may be external to the DNN system 900 and communicate with the DNN system 900 through a network.

### Example Computing Device

FIG. 10 is a block diagram of an example computing device 1000, in accordance with various embodiments. In some embodiments, the computing device 1000 can be used as the DNN system 900 in FIG. 9. A number of components are illustrated in FIG. 10 as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, but the computing device 1000 may include interface circuitry for coupling to the one or more components. For example, the computing device 1000 may not include a display device 1006, but may include display device interface circuitry (e.g., a connector and driver circuitry) to which a display device 1006 may be coupled. In another set of examples, the computing device 1000 may not include an audio input device 1018 or an audio output device 1008, but may include audio input or output device interface circuitry (e.g., connectors and supporting circuitry) to which an audio input device 1018 or audio output device 1008 may be coupled.

The computing device 1000 may include a processing device 1002 (e.g., one or more processing devices). The processing device 1002 processes electronic data from registers and/or memory to transform that electronic data into other electronic data that may be stored in registers and/or memory. The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1004 may include memory that shares a die with the processing device 1002. In some embodiments, the memory 1004 includes one or more non-transitory computer-readable media storing instructions executable to perform operations for video segmentation, e.g., the method 700 described above in conjunction with FIG. 7 or some operations performed by the video segmentation system 200 (e.g., the video processing network 230) described above in conjunction with FIG. 2. The instructions stored in the one or more non-transitory computer-readable media may be executed by the processing device 2402.

In some embodiments, the computing device 1000 may include a communication chip 1012 (e.g., one or more communication chips). For example, the communication chip 1012 may be configured for managing wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1012 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1012 may operate in accordance with other wireless protocols in other embodiments. The computing device 1000 may include an antenna 1022 to facilitate wireless communications and/or to receive other wireless communications (such as AM or FM radio transmissions).

In some embodiments, the communication chip 1012 may manage wired communications, such as electrical, optical, or any other suitable communication protocols (e.g., the Ethernet). As noted above, the communication chip 1012 may include multiple communication chips. For instance, a first communication chip 1012 may be dedicated to shorter-range wireless communications such as Wi-Fi or Bluetooth, and a second communication chip 1012 may be dedicated to longer-range wireless communications such as global positioning system (GPS), EDGE, GPRS, CDMA, WiMAX, LTE, EV-DO, or others. In some embodiments, a first communication chip 1012 may be dedicated to wireless communications, and a second communication chip 1012 may be dedicated to wired communications.

The computing device 1000 may include battery/power circuitry 1014. The battery/power circuitry 1014 may include one or more energy storage devices (e.g., batteries or capacitors) and/or circuitry for coupling components of the computing device 1000 to an energy source separate from the computing device 1000 (e.g., AC line power).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include another output device 1010 (or corresponding interface circuitry, as discussed above). Examples of the other output device 1010 may include an audio codec, a video codec, a printer, a wired or wireless transmitter for providing information to other devices, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1000 may be any other electronic device that processes data.

### SELECT EXAMPLES

The following paragraphs provide various examples of the embodiments disclosed herein.

Example 1 provides a method of video segmentation, the method including generating, by one or more first layers in a neural network, a first feature map from a first frame in a video; storing the first feature map in a memory, where the memory has stored one or more contextual feature maps generated from one or more frames that are precedent to the first frame in the video; determining, by one or more second layers in the neural network based on a first group of feature maps including the first feature map and the one or more contextual feature maps, whether the first frame is in a segment of the video, the segment including a sequence of consecutive frames in the video; generating, by the one or more first layers, a second feature map from a second frame that is subsequent to the first frame in a video; updating the memory to store the second feature map; and after updating the memory, determining, by the one or more second layers based on a second group of feature maps including the first feature map and the second feature map, whether the second frame is in the segment of the video.

Example 2 provides the method of example 1, where updating the memory to store the second feature map includes removing one of the one or more contextual feature maps from the memory.

Example 3 provides the method of example 1 or 2, where a number of feature maps in the first group of feature maps is different from a number of feature maps in the second group of feature maps.

Example 4 provides the method of any of the preceding examples, where the one or more first layers include a convolutional layer.

Example 5 provides the method of any of the preceding examples, where the one or more first layers includes a first layer and a second layer, the first feature map is generated by the first layer, and a contextual feature map is generated by the second layer.

Example 6 provides the method of any of the preceding examples, where the first group of feature maps is stored in an order in the memory, and the order is determined based on times when the feature maps in the first group are generated.

Example 7 provides the method of any of the preceding examples, further including generating, by the one or more first layers, a third feature map from the first feature map; storing the third feature map in a memory; after storing the third feature map, retrieving a third group of feature maps from the memory, where the third group of feature maps includes the third feature map and the one or more contextual feature maps; and determining, by the one or more second layers based on the third group of feature maps, whether the first frame is in the segment of the video.

Example 8 provides one or more non-transitory computer-readable media storing instructions executable to perform operations, the operations including generating, by one or more first layers in a neural network, a first feature map from a first frame in a video; storing the first feature map in a memory, where the memory has stored one or more contextual feature maps generated from one or more frames that are precedent to the first frame in the video; determining, by one or more second layers in the neural network based on a first group of feature maps including the first feature map and the one or more contextual feature maps, whether the first frame is in a segment of the video, the segment including a sequence of consecutive frames in the video; generating, by the one or more first layers, a second feature map from a second frame that is subsequent to the first frame in a video; updating the memory to store the second feature map; and after updating the memory, determining, by the one or more second layers based on a second group of feature maps including the first feature map and the second feature map, whether the second frame is in the segment of the video.

Example 9 provides the one or more non-transitory computer-readable media of example 8, where updating the memory to store the second feature map includes removing one of the one or more contextual feature maps from the memory.

Example 10 provides the one or more non-transitory computer-readable media of example 8 or 9, where a number of feature maps in the first group of feature maps is different from a number of feature maps in the second group of feature maps.

Example 11 provides the one or more non-transitory computer-readable media of any one of examples 8-10, where the one or more first layers include a convolutional layer.

Example 12 provides the one or more non-transitory computer-readable media of any one of examples 8-11, where the one or more first layers includes a first layer and a second layer, the first feature map is generated by the first layer, and a contextual feature map is generated by the second layer.

Example 13 provides the one or more non-transitory computer-readable media of any one of examples 8-12, where the first group of feature maps is stored in an order in the memory, and the order is determined based on times when the feature maps in the first group are generated.

Example 14 provides the one or more non-transitory computer-readable media of any one of examples 8-13, where the operations further include generating, by the one or more first layers, a third feature map from the first feature map; storing the third feature map in a memory; after storing the third feature map, retrieving a third group of feature maps from the memory, where the third group of feature maps includes the third feature map and the one or more contextual feature maps; and determining, by the one or more second layers based on the third group of feature maps, whether the first frame is in the segment of the video.

Example 15 provides an apparatus, the apparatus including a computer processor for executing computer program instructions; and a non-transitory computer-readable memory storing computer program instructions executable by the computer processor to perform operations including generating, by one or more first layers in a neural network, a first feature map from a first frame in a video, storing the first feature map in a memory, where the memory has stored one or more contextual feature maps generated from one or more frames that are precedent to the first frame in the video, determining, by one or more second layers in the neural network based on a first group of feature maps including the first feature map and the one or more contextual feature maps, whether the first frame is in a segment of the video, the segment including a sequence of consecutive frames in the video, generating, by the one or more first layers, a second feature map from a second frame that is subsequent to the first frame in a video, updating the memory to store the second feature map, and after updating the memory, determining, by the one or more second layers based on a second group of feature maps including the first feature map and the second feature map, whether the second frame is in the segment of the video.

Example 16 provides the apparatus of example 15, where updating the memory to store the second feature map includes removing one of the one or more contextual feature maps from the memory.

Example 17 provides the apparatus of example 15 or 16, where a number of feature maps in the first group of feature maps is different from a number of feature maps in the second group of feature maps.

Example 18 provides the apparatus of any one of examples 15-17, where the one or more first layers include a convolutional layer.

Example 19 provides the apparatus of any one of examples 15-17, where the one or more first layers includes a first layer and a second layer, the first feature map is generated by the first layer, and a contextual feature map is generated by the second layer.

Example 20 provides the apparatus of any one of examples 15-17, where the first group of feature maps is stored in an order in the memory, and the order is determined based on times when the feature maps in the first group are generated.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1-20. (canceled)

21. A method of video segmentation, the method comprising:
generating, by one or more first layers in a neural network, a first feature map from a first frame in a video;
storing the first feature map in a memory, wherein the memory has stored one or more contextual feature maps generated from one or more frames that are precedent to the first frame in the video;
determining, by one or more second layers in the neural network based on a first group of feature maps including the first feature map and the one or more contextual feature maps, whether the first frame is in a segment of the video, the segment comprising a sequence of consecutive frames in the video;
generating, by the one or more first layers, a second feature map from a second frame that is subsequent to the first frame in a video;
updating the memory to store the second feature map; and
after updating the memory, determining, by the one or more second layers based on a second group of feature maps including the first feature map and the second feature map, whether the second frame is in the segment of the video.

22. The method of claim 21, wherein updating the memory to store the second feature map comprises:
removing one of the one or more contextual feature maps from the memory.

23. The method of claim 21, wherein a number of feature maps in the first group of feature maps is different from a number of feature maps in the second group of feature maps.

24. The method of claim 21, wherein the one or more first layers comprise a convolutional layer.

25. The method of claim 21, wherein the one or more first layers comprises a first layer and a second layer, the first feature map is generated by the first layer, and a contextual feature map is generated by the second layer.

26. The method of claim 21, wherein the first group of feature maps is stored in an order in the memory, and the order is determined based on times when the feature maps in the first group are generated.

27. The method of claim 21, further comprising:
generating, by the one or more first layers, a third feature map from the first feature map;
storing the third feature map in a memory;
after storing the third feature map, retrieving a third group of feature maps from the memory, wherein the third group of feature maps comprises the third feature map and the one or more contextual feature maps; and
determining, by the one or more second layers based on the third group of feature maps, whether the first frame is in the segment of the video.

28. One or more non-transitory computer-readable media storing instructions executable to perform operations, the operations comprising:
generating, by one or more first layers in a neural network, a first feature map from a first frame in a video;
storing the first feature map in a memory, wherein the memory has stored one or more contextual feature maps generated from one or more frames that are precedent to the first frame in the video;
determining, by one or more second layers in the neural network based on a first group of feature maps including the first feature map and the one or more contextual feature maps, whether the first frame is in a segment of the video, the segment comprising a sequence of consecutive frames in the video;
generating, by the one or more first layers, a second feature map from a second frame that is subsequent to the first frame in a video;
updating the memory to store the second feature map; and
after updating the memory, determining, by the one or more second layers based on a second group of feature maps including the first feature map and the second feature map, whether the second frame is in the segment of the video.

29. The one or more non-transitory computer-readable media of claim 28, wherein updating the memory to store the second feature map comprises:
removing one of the one or more contextual feature maps from the memory.

30. The one or more non-transitory computer-readable media of claim 28, wherein a number of feature maps in the first group of feature maps is different from a number of feature maps in the second group of feature maps.

31. The one or more non-transitory computer-readable media of claim 28, wherein the one or more first layers comprise a convolutional layer.

32. The one or more non-transitory computer-readable media of claim 28, wherein the one or more first layers comprises a first layer and a second layer, the first feature map is generated by the first layer, and a contextual feature map is generated by the second layer.

33. The one or more non-transitory computer-readable media of claim 28, wherein the first group of feature maps is stored in an order in the memory, and the order is determined based on times when the feature maps in the first group are generated.

34. The one or more non-transitory computer-readable media of claim 28, wherein the operations further comprise:
generating, by the one or more first layers, a third feature map from the first feature map;
storing the third feature map in a memory;
after storing the third feature map, retrieving a third group of feature maps from the memory, wherein the third group of feature maps comprises the third feature map and the one or more contextual feature maps; and
determining, by the one or more second layers based on the third group of feature maps, whether the first frame is in the segment of the video.

35. An apparatus, the apparatus comprising:
a computer processor for executing computer program instructions; and
a non-transitory computer-readable memory storing computer program instructions executable by the computer processor to perform operations comprising:
generating, by one or more first layers in a neural network, a first feature map from a first frame in a video,
storing the first feature map in a memory, wherein the memory has stored one or more contextual feature maps generated from one or more frames that are precedent to the first frame in the video,
determining, by one or more second layers in the neural network based on a first group of feature maps including the first feature map and the one or more contextual feature maps, whether the first frame is in a segment of the video, the segment comprising a sequence of consecutive frames in the video,
generating, by the one or more first layers, a second feature map from a second frame that is subsequent to the first frame in a video,
updating the memory to store the second feature map, and
after updating the memory, determining, by the one or more second layers based on a second group of feature maps including the first feature map and the second feature map, whether the second frame is in the segment of the video.

36. The apparatus of claim 35, wherein updating the memory to store the second feature map comprises:
removing one of the one or more contextual feature maps from the memory.

37. The apparatus of claim 35, wherein a number of feature maps in the first group of feature maps is different from a number of feature maps in the second group of feature maps.

38. The apparatus of claim 35, wherein the one or more first layers comprise a convolutional layer.

39. The apparatus of claim 35, wherein the one or more first layers comprises a first layer and a second layer, the first feature map is generated by the first layer, and a contextual feature map is generated by the second layer.

40. The apparatus of claim 35, wherein the first group of feature maps is stored in an order in the memory, and the order is determined based on times when the feature maps in the first group are generated.
